(19) United States
(12) Patent Application Publication
(10) Pub. No.: US 2019/0347692 A1
(43) Pub. Date: Nov. 14, 2019

(54) Providing advertisements on a decentralized social network

(71) Applicant: Jens-Peter Horvath, Holzkirchen (DE)

(72) Inventor: Jens-Peter Horvath, Holzkirchen (DE)

(21) Appl. No.: 15/978,205

(22) Filed: May 14, 2018

(51) Int. Cl. G06Q 30/02; G06Q 50/00; H04L 29/08

(52) U.S. Cl. CPC G06Q 30/0257; G06Q 50/01; H04L 67/104; G06Q 30/0277; G06Q 30/0273

(57) ABSTRACT

A computer implemented method for displaying advertisements to members of a decentralized social network, allowing the members to monetize their data.

### TECHNICAL FIELD

This disclosure relates to advertising in decentralized social networking.

### BACKGROUND

A decentralized social network can leave the data on the users device. This allows the users the control of their data. So the user can decide who is allowed to access the data and the user can decide how to monetize his data.

In this decentralized social network the data of the users is not aggregated in a central server. So no single instance can query the user data and provide content like advertisements specific to the user data.

### SUMMARY

A computer implemented method for displaying advertisements to users of a decentralized social network, allowing the user to monetize his data. The user will receive rewards for queries he allows to be executed on his device. If a query matches he can receive a reward for viewing the advertisement that is attached to the query. The user can receive rewards for forwarding the query. The method allows subqueries to other applications on the users device.

### BRIEF DESCRIPTION OF THE DRAWINGS

FIG. 1 is a flow chart of an example of a method for rewarding a user for allowing a query on his attributes and getting rewarded for viewing the advertisement.

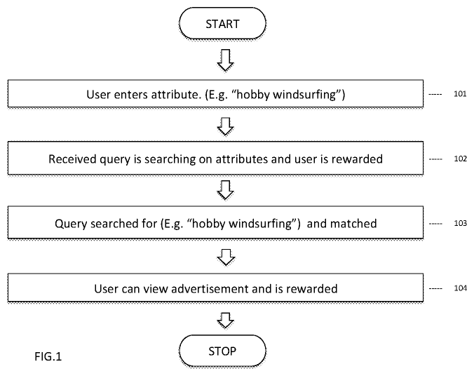

FIG. 2 is a flow chart of an example of a method for rewarding a user for allowing a query on his attributes that does not match.

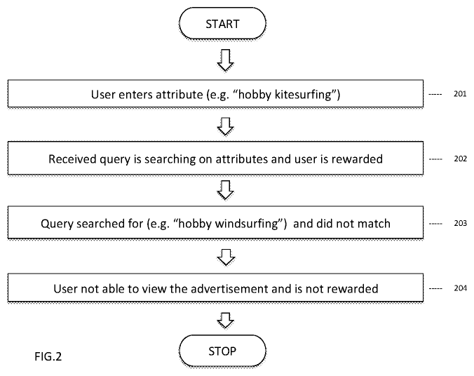

### DETAILED DESCRIPTION

On a decentralized social network the data of the users is not aggregated in a central server. So no single instance can query the user data and provide content like advertisements specific to the user data. The invention solves the problem by enabling the user to allow queries on the data that is stored on his device.

The query is transferred peer to peer in the decentralized social network and/or is downloaded by the device from servers.

In case the query is provided by servers the device and eventually the user are informed via push notifications when new queries are available on the servers and the device can download the new query. The device can also download the queries on a regularly bases or triggered by events like network change or location change.

The content package for downloading a query contains the query and additional Data that is attached to each query that is downloaded with the content package. The query is executed on the user device and queries data the user provided. The query can contain a sql statement that is executed by the sqlite data base on his device but it can also access data on the device like messages or emails. If the query matches content e.g. an advertisement can be shown to the user or the query can be forwarded to the contacts of the user.

The query has a privacy scope. The scope can be e.g. public, private, friends or business. The user can classify his data in the same scope. The scopes define ranges of restriction. E.g. private is more strict than public. The query will only access data that is within its scope or within a broader scope. A query that is allowed to access private data can also access data with the scope public.

The user can restrict the query scope and amount of queries for chosen advertisers. This is in addition to the fact that the user has the control over his data and can decide if he wants to view an advertisement. E.g. in case of a job advertisement the user can control the queries from potential employers and can ensure that the current employer has under no circumstances access to his data.

The query is also used for contact request. The party requesting the contact can be anonymous till the query matches. So e.g. a party searching for a business partner will only be disclosed if interests and other attributes of the user profile are matching.

A reward scheme is attached to the query. The scheme contains the value for the reward the user receives for executing the query. The value for the reward the user receives for viewing the content or for forwarding the query and the affiliate rewards. The affiliate rewards are rewards that are received when the user follows url links in the content to the website of a merchant and purchases. The affiliate reward can also be issued to the user that was forwarding the query.

The reward can be a negative number. This allows providing paid content.

The user can enrich his data with search relevant attributes. The attributes have a scope that determines the degree of privacy of the attribute. The more attributes the user provides the better will be the search results of the queries. If the query matches the interest of the user most it has more attention of the user and is more valuable for the advertiser. The advertiser will offer a higher reward for queries matching more attributes. The more attributes the user maintains the more he can receive in query rewards.

The attributes are additionally enriched by an artificial intelligence aided process that is collecting and processing data from all sensors of the device of the user. The collected data never leaves the device of the user. If the user decides to allow it the queries can also include the banking information the user stored on his device. E.g. an advertisement for a yacht can ensure with this query that the user can afford a yacht. If the query retrieves detailed information about the user the user has to be aware of that following a url that is linked with the query allows to draw conclusions. In case of the example it is an advantage since the advertiser can assume the prospect is able by the yacht.

The user can access the information the query matched. And he can decide if he wants to view the advertisement.

To access the banking information a query is sent to the banking application on the device. The query is signed and the banking application can verify the origin of the query. The banking application returns a signed result of the query. The information about the banking application including the public key and the app name can be provided as an attachment to the query or it can be retrieved out of a information table that is downloaded. The information table contains the public keys of the applications supporting the query protocol, the domain of the application (e.g. banking, health, fitness). On the users device additional information will be added to the table e.g. the information if the application is installed and the information if the user wants to allow access to the application.

1. A computer implemented method comprising:
Downloading a query and its attached data from a server.
Executing the query on the data available on the users device
Showing the user the Advertisement attached to the query if the query matches.

2. The method of claim 1, wherein downloading comprises download the on a regularly bases or triggered by events like network change or location change.

3. The method of claim 2, wherein downloading comprises download triggered by an event.

4. The method of claim 3, wherein downloading comprises receiving a query and its attached data from another device.

5. The method of claim 4, further comprising rewarding the user for executing the query. The amount of reward is stated in the data attached to the query.

6. The method of claim 5, further comprising rewarding the user for viewing the advertisement. The amount of reward is stated in the data attached to the query.

7. The method of claim 6, further comprising allowing the user to restrict the query scope and amount of queries for chosen advertisers. A string identifying the advertiser is attached to the query.

8. The method of claim 7, further comprising allowing the user to forward the query.

9. The method of claim 8, further comprising rewarding the user for forwarding the advertisement.

10. The method of claim 9, wherein rewarding the user for forwarding the advertisement comprises receiving rewards that are issued when the user follows links in the advertisement to the website of a merchant and purchases.

11. The method of claim 10, further comprising cross application subqueries. Cross application subqueries are queries to another application on the same device. Queries to another application comprises receiving the information if the query matches or not. The result is provided to the main query.

12. The method of claim 11, wherein the reward for viewing is negative.

13. The method of claim 12, comprising informing the user about queries that did not match due to attributes the user did not maintain.

14. The method of claim 13, wherein informing the user comprises informing the user about queries that did not match due to queries to other applications.

15. A computer implemented method comprising:
Extracting from a query a subquery regarding another application.
Signing the subquery with the public key of a private public key pair issued by a key issuing authority allowing identifying the signing application.
Forwarding a subquery to the application identified in the subquery on the same device.
Receiving the information if the query matches signed by the public key part of the other application.
Validating the signature.
Using the result in the main query.
